(19) United States
(12) Patent Application Publication
(10) Pub. No.: US 2009/0251610 A1
(43) Pub. Date: Oct. 8, 2009

(54) VERTICAL BLANKING INTERVAL SLICER AND RELATED METHOD

(76) Inventors: Hsin-Chung Wang, Tainan County (TW); Hung-Shih Lin, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/099,764

(22) Filed: Apr. 8, 2008

(51) Int. Cl. H04N 5/14

(52) U.S. Cl. 348/571; 348/E05.062

(57) ABSTRACT

A vertical blanking interval slicer includes: an analog-to-digital conversion unit for performing analog-to-digital conversion on original video data in the vertical blanking interval to generate a digital video data; a mode setting unit for setting a data rate according to the original video data in the vertical blanking interval; a digital phase lock loop unit, coupled to the analog-to-digital conversion unit and the mode setting unit, for generating a target clock according to the data rate; a sampler, coupled to the analog-to-digital conversion unit and the digital phase lock loop unit, for sampling the digital video data to generate a target video data of the original video data in the vertical blanking interval; an equalizer, coupled to the sampler and the digital phase lock loop unit, for equalizing the target video data to generate an adjusted target video data.

### BACKGROUND OF THE INVENTION

1. Field of the Invention

The present invention relates to digital data processing on television signals, and more particularly, to a method and circuit for slicing digital data in a vertical blanking interval.

2. Description of the Prior Art

Generally, the present TV specifications can be classified into an NTSC (National Television Standards Committee) format and a PAL (Phase Alternation Line) format. In NTSC specifications, the television display corresponds to 525 scan lines, wherein 480 scan lines are active scan lines for displaying images. In PAL specifications, the television display corresponds to 625 scan lines, wherein 576 scan lines are active scan lines for displaying images. The remaining scanning lines are called the vertical blanking interval (VBI). The vertical blanking interval is utilized to transmit closed caption (CC), teletext, video program system (VPS), wide screen signaling (WSS) and other such auxiliary information. Such information is often provided as a digital data stream.

Therefore, a display apparatus generally has a vertical blanking interval slicer (VBI slicer) to access the auxiliary video data transmitted in the vertical blanking interval in the NTSC or PAL standards. However, the data rate and the format of the video data in the vertical blanking interval in the NTSC standard, such as CC, VPS and WSS, are different from those of the video data in the vertical blanking interval in PAL standard, such as teletext and WSS. Therefore, separate circuits are needed to convert a digital video stream into a standard NTSC or PAL signal. FIG. 1 is a block diagram illustrating a prior art vertical blanking interval slicer 100. The vertical blanking interval slicer 100 comprises: an analog-to-digital converter 110 for performing analog-to-digital conversion on original video data in the vertical blanking interval to generate digital video data; a digital phase lock loop unit 120, coupled to the analog-to-digital converter 110, for generating a target clock according to the data rate of the video data in the vertical blanking interval complying with NTSC or PAL standard; and a sampler 130, coupled to the analog-to-digital converter 110 and the digital phase lock loop unit 120, for sampling the digital video data according to the target clock generated from the digital phase lock loop unit 120 to generate target video data of the original video data in the vertical blanking interval. The vertical blanking interval slicer 100 is only utilized in PAL or NTSC standards.

Additionally, during the signal transmission period, the signal is influenced by the noise and the channel effect such as thermal noise and inter-symbol interference (ISI), resulting in high bit error rate (BER) after VBI slicing.

### SUMMARY OF THE INVENTION

It is therefore one of the objectives of the claimed invention to provide a method and a slicer for slicing digital data in a vertical blanking interval to solve the above-mentioned problems.

According to one embodiment of the claimed invention, a vertical blanking interval slicer comprises: an analog-to-digital conversion unit for performing analog-to-digital conversion on at least original video data in the vertical blanking interval to generate a digital video data; a mode setting unit for setting a data rate according to the original video data in the vertical blanking interval; a digital phase lock loop unit, coupled to the analog-to-digital conversion unit and the mode setting unit, for generating a target clock according to the data rate; a sampler, coupled to the analog-to-digital conversion unit and the digital phase lock loop unit, for sampling the digital video data to generate a target video data of the original video data in the vertical blanking interval; an equalizer, coupled to the sampler and the digital phase lock loop unit, for equalizing the target video data to generate an adjusted target video data.

According to one embodiment of the claimed invention, a vertical blanking interval slicing method comprises: performing analog-to-digital conversion on original video data in the vertical blanking interval to generate a digital video data; setting a data rate according to the original video data in the vertical blanking interval; generating a target clock according to the data rate; sampling the digital video data to generate a target video data of the original video data in the vertical blanking interval; equalizing the target video data to generate an adjusted target video data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is block diagram illustrating a prior art vertical blanking interval slicer.

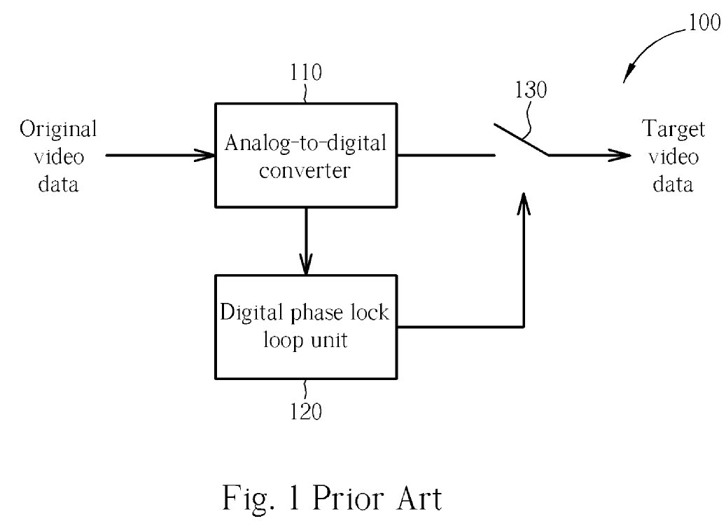

FIG. 2 is block diagram illustrating a vertical blanking interval slicer according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

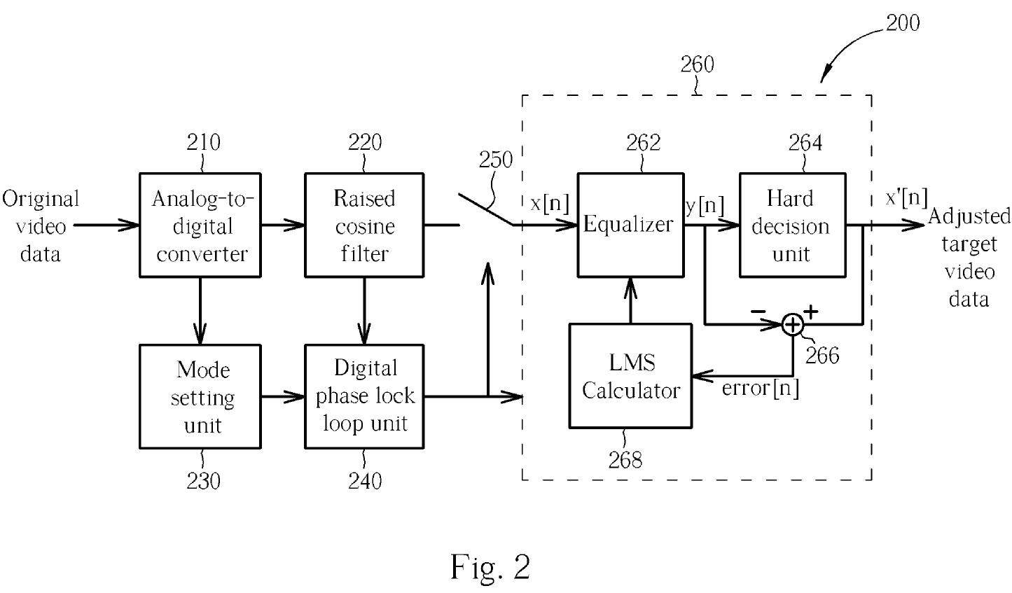

Please refer to FIG. 2. FIG. 2 is block diagram illustrating a vertical blanking interval slicer 200 according to an exemplary embodiment of the present invention. In this exemplary embodiment, the vertical blanking interval slicer 200 comprises an analog-to-digital converter 210, a raised cosine filter 220, a mode setting unit 230, a digital phase lock loop unit 240, a sampler 250 and a least mean square (LMS)-based decision directed equalizer 260. As shown in FIG. 2, the LMS-based decision directed equalizer 260 comprises an equalizer 262, a hard decision unit 264, an adder 266 and an LMS calculator 268.

Generally, original video data such as teletext and WSS in the vertical blanking interval are modulated by pulse amplitude modulation (PAM) and are analog video data. The analog-to-digital converter 210 first converts the original (analog) video data to generate an output (i.e., digitized data), and the raised cosine filter 220 performs low-pass filtering upon the output of the analog-to-digital converter 210 to generate digital video data.

The raised cosine filter 220 is utilized for reducing noise and inter-symbol interference and, without departing from the spirit of the present invention, other low-pass filters having the same functions can replace the raised cosine filter 220. In other embodiments, the raised cosine filter 220 can even be removed, and the output of the analog-to-digital converter 210 directly serves as the digital video data. In other words, the raised cosine filter 220 is an optional component, depending upon design requirements.

Then the mode setting unit 230 sets the mode of the TV video system and determines whether the TV video system is in compliance with the NTSC standard or the PAL standard. If the setting mode is for the NTSC standard, the mode setting unit 230 sets the data rates and formats of the CC, VPS, WSS for NTSC systems. On the other hand, if the setting mode is for the PAL standard, the mode setting unit 230 sets the data rates and formats of the teletext, WSS for PAL systems. The data rate(s) and format(s) set by the mode setting unit 230 are utilized in the following digital phase lock loop unit 240.

Next, the digital phase lock loop unit 240 is utilized to generate a required clock from the digital video data. Taking the teletext data of the PAL standard as an example, first, the digital phase lock loop unit 240 utilizes the digital video data outputted from the raised cosine filter 220 and the data rate of the teletext data provided by the mode setting unit 230 to generate the required clock. In this example, the required clock frequency is 6.9375 MHz and is the same as the data rate of the teletext data. However, this is for illustrative purposes only and not meant to be a limitation of the present invention.

Afterwards, the sampler 250 utilizes the clock generated by the digital phase lock loop unit 240 to sample the digital video data for generating a target video data. Taking the teletext data of the PAL standard as an example, the data rate of the digital video data is 24.576 MHz and the clock frequency generated by the digital phase lock loop unit 240 is 6.9375 MHz. The sampler 250 samples the digital video data at the sampling frequency 6.9375 MHz and then generates the teletext data of the target video data.

The different data in the vertical blanking interval in the PAL standard are carried in the waveform on the different lines in the vertical blanking interval; therefore, data in the vertical blanking interval in the PAL standard such as teletext, WSS, etc. are all processed sequentially according to the method described above. For the NTSC standard, the process of the data in the vertical blanking interval are the same as the process of the data in the vertical blanking interval in the PAL standard.

However, because the original video data is influenced by noise and the channel effect such as thermal noise and inter-symbol interference (ISI) during the signal transmission period, the target video data may have high bit error rates. Therefore, the LMS-based decision directed equalizer 260 is provided to reduce the ghost interference due to inter-symbol interference.

To reduce the ghost interference, the equalizer 260 equalizes the target video data x[n] to generate an output y[n] of the equalizer 260 at the clock frequency generated from the digital phase lock loop unit 240, where the output y[n] of the equalizer 260 is the summation of a series of x[n] multiplied by the corresponding parameter C[n]. Then the output of the equalizer 260 is processed by the hard decision unit 264 to generate an output x′[n] of the hard decision unit 264. Output x′[n] of the hard decision unit 264 is also an adjusted target video data as needed. The output x′[n] of the hard decision unit 264 minus the output y[n] of the equalizer 260 by the adder 266 becomes an error data error[n]. Then the LMS calculator 268 utilizes the error data error[n] to determine the corresponding parameter of x[n]. The formulas of the above operations are as follows:

y[n]=ΣⱼCⱼ[n]*x[n−j] (1)

error[n]=x′[n]−y[n] (2)

Cⱼ[n−1]=Cⱼ[n]+μ*error[n]*x[n] (3)

In the above formulas, μ is a step-size parameter and j is a step number, and both of them are set by the designer's considerations. As a person skilled in this art can readily understand operations of the LMS-based decision directed equalizer 260 mentioned above, further description is omitted here for the sake of brevity.

Please note that, the LMS-based decision directed equalizer 260 is an exemplary device in the present invention. In other embodiments, the LMS-based decision directed equalizer 260 is replaced by other type of equalizers, and the equalizer 262 is also replaced by other adaptive filters. These alternative designs all fall in the scope of the present invention.

Briefly summarized, the above VBI slicing method employed by the vertical blanking interval slicer 200 shown in FIG. 2 includes the steps of performing analog-to-digital conversion on original video data in the vertical blanking interval to generate a digital video data; setting a data rate according to the original video data in the vertical blanking interval; generating a target clock according to the data rate; sampling the digital video data to generate a target video data of the original video data in the vertical blanking interval; and equalizing the target video data to generate an adjusted target video data.

Those skilled in the art will readily observe that numerous modifications and alterations of the device and method may be made while retaining the teachings of the invention.

What is claimed is:

1. A vertical blanking interval slicer, comprising:
an analog-to-digital conversion unit for performing analog-to-digital conversion on original video data in a vertical blanking interval to generate a digital video data;
a mode setting unit for setting a data rate according to the original video data in the vertical blanking interval;
a digital phase lock loop unit, coupled to the analog-to-digital conversion unit and the mode setting unit, for generating a target clock according to the data rate;
a sampler, coupled to the analog-to-digital conversion unit and the digital phase lock loop unit, for sampling the digital video data to generate a target video data of the original video data in the vertical blanking interval;
an equalizer, coupled to the sampler and the digital phase lock loop unit, for equalizing the target video data to generate an adjusted target video data.

2. The slicer of claim 1, wherein the analog-to-digital conversion unit comprises:
an analog-to-digital converter for performing analog-to-digital conversion on the original video data in the vertical blanking interval; and
a low-pass filter, coupled to the analog-to-digital converter, for low-pass filtering an output of the analog-to-digital converter corresponding to the original video data to generate the digital video data.

3. The slicer of claim 2, wherein the low-pass filter is a raised cosine filter.

4. The slicer of claim 1, wherein the original video data comprises video program system (VPS) data.

5. The slicer of claim 1, wherein the original video data comprises closed caption (CC) data.

6. The slicer of claim 1, wherein the original video data comprises teletext data.

7. The slicer of claim 1, wherein the original video data comprises wide screen signaling (WSS) data.

8. A vertical blanking interval slicing method, comprising:
performing analog-to-digital conversion on original video data in a vertical blanking interval to generate a digital video data;
setting a data rate according to the original video data in the vertical blanking interval;
generating a target clock according to the data rate;
sampling the digital video data to generate a target video data of the original video data in the vertical blanking interval; and
equalizing the target video data to generate an adjusted target video data.

9. The method of claim 8, wherein the step of performing analog-to-digital conversion on original video data in the vertical blanking interval to generate a digital video data comprises:
performing analog-to-digital conversion on the original video data in the vertical blanking interval; and
low-pass filtering an output of the analog-to-digital converter corresponding to the original video data to generate the digital video data.

10. The method of claim 9, wherein the operation of low-pass filtering the first digital video data is implemented by a raised cosine filter.

11. The method of claim 8, wherein the original video data comprises video program system (VPS) data.

12. The method of claim 8, wherein the original video data comprises closed caption (CC) data.

13. The method of claim 8, wherein the original video data comprises teletext data.

14. The method of claim 8, wherein the original video data comprises wide screen signaling (WSS) data.
